(19) United States
(12) Patent Application Publication
(10) Pub. No.: US 2026/0140693 A1
(43) Pub. Date: May 21, 2026

(54) VOICE-CONTROLLED DISPLAYING SYSTEM AND VOICE-CONTROLLED DISPLAY

(71) Applicant: Iris Optronics Co., Ltd., Tainan City (TW)

(72) Inventors: Chih Ming WANG, Tainan City (TW); Chi Chang LIAO, Tainan City (TW)

(21) Appl. No.: 19/264,885

(22) Filed: Jul. 10, 2025

(30) Foreign Application Priority Data
Nov. 20, 2024 (TW) 113144760
Nov. 20, 2024 (TW) 113212701

(51) Int. Cl. G06F 3/16; G06F 1/18; G06F 1/26; G09G 3/36

(52) U.S. Cl. CPC G06F 3/167; G06F 1/189; G06F 1/26; G06F 3/162; G09G 3/36; G09G 2300/0486; G09G 2354/00

(57) ABSTRACT

A voice-controlled displaying system includes a controller and a display. The controller includes a voice receiving module, a processing module and a transmitting module. The voice receiving module is configured to receive a speech instruction, and transforms the speech instruction into a speech signal. The processing module is signally connected to the voice receiving module, and identifies the speech signal to generate a controlling instruction. The transmitting module is signally connected to the processing module, and configured to transmit the controlling instruction. The display includes a receiving module and a displaying module. The receiving module is signally connected to the transmitting module, and receives the controlling instruction. The displaying module is signally connected to the receiving module, and displays a display screen according to the controlling instruction.

### RELATED APPLICATIONS

This application claims priority to Taiwan Application Serial Number 113144760, filed Nov. 20, 2024 and Taiwan Application Serial Number 113212701, filed Nov. 20, 2024, which are herein incorporated by reference.

### BACKGROUND

### Technical Field

The present disclosure relates to a displaying system and a display. More particularly, the present disclosure relates to a voice-controlled displaying system and a voice-controlled display.

### Description of Related Art

The conventional displaying device consumes large amount of electric power while displaying the screen for long time. Hence, the aforementioned displaying device cannot be used as a sign, which displays screen for a long time. The power is consumed while the Cholesteric Liquid Crystal Display (ChLCD) switching the screen, the power is not consumed while the ChLCD maintains the screen. However, when the ChLCD is used as a sign, the screen can only display single frame or display the image or information stored in advance in different times. When the ChLCD is used as an electronic book, the user needs to touch the display to switch the page or the screen.

Thus, developing a voice-controlled displaying system and a voice-controlled display which can be controlled by the user and display the screen for a long time are commercially desirable.

### SUMMARY

According to one aspect of the present disclosure, a voice-controlled displaying system includes a controller and a display. The controller includes a voice receiving module, a processing module and a transmitting module. The voice receiving module is configured to receive a speech instruction, and transforms the speech instruction into a speech signal. The processing module is signally connected to the voice receiving module, and identifies the speech signal to generate a controlling instruction. The transmitting module is signally connected to the processing module, and is configured to transmit the controlling instruction. The display includes a receiving module and a displaying module. The receiving module is signally connected to the transmitting module, and receives the controlling instruction. The displaying module is signally connected to the receiving module, and displays a display screen according to the controlling instruction.

According to another aspect of the present disclosure, a voice-controlled display includes a voice receiving module, a processing module and a displaying module. The voice receiving module is configured to receive a speech instruction, and transforms the speech instruction into a speech signal. The processing module is signally connected to the voice receiving module, and identifies the speech signal to generate a controlling instruction. The displaying module is signally connected to the processing module, and displays a display screen according to the controlling instruction.

### BRIEF DESCRIPTION OF THE DRAWINGS

The present disclosure can be more fully understood by reading the following detailed description of the embodiment, with reference made to the accompanying drawings as follows:

FIG. 1 shows a block diagram of a voice-controlled displaying system according to a first embodiment of the present disclosure.

FIG. 2 shows a block diagram of a voice-controlled displaying system according to a second embodiment of the present disclosure.

FIG. 3 shows a block diagram of a voice-controlled displaying system according to a third embodiment of the present disclosure.

FIG. 4 shows a block diagram of a voice-controlled displaying system according to a fourth embodiment of the present disclosure.

FIG. 5 shows a block diagram of a voice-controlled display according to a fifth embodiment of the present disclosure.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected to” another element, it can be directly connected to other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

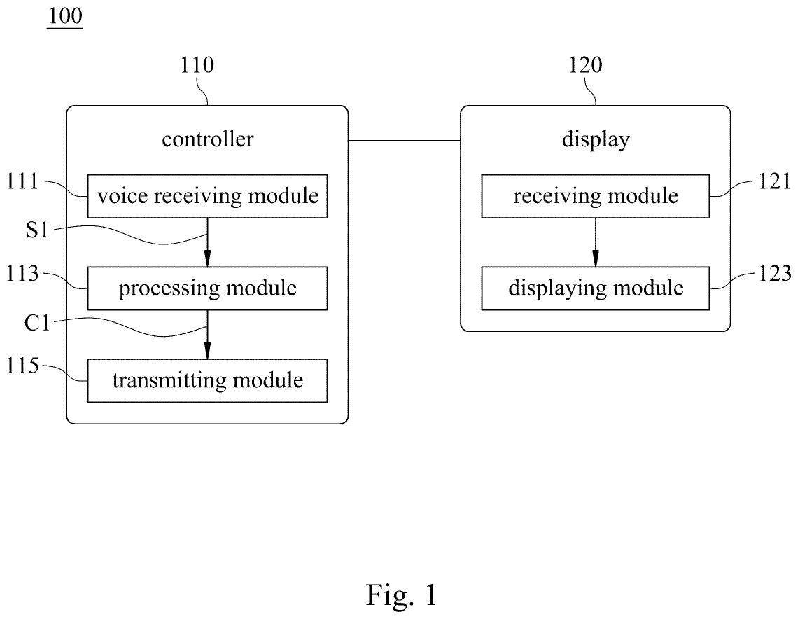

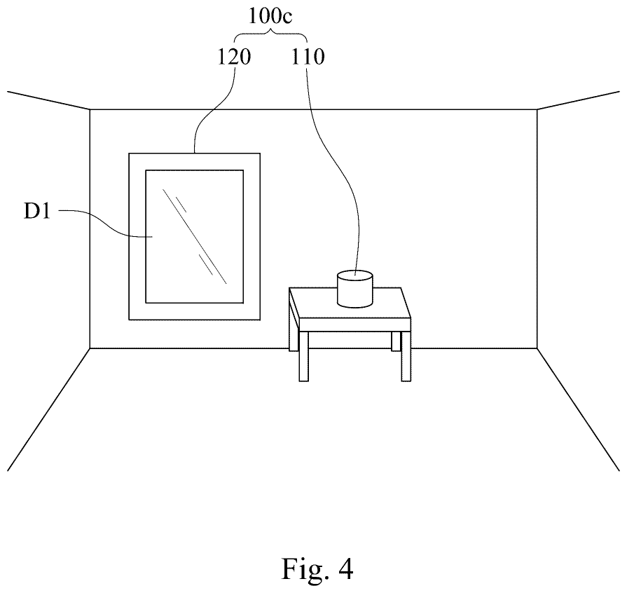

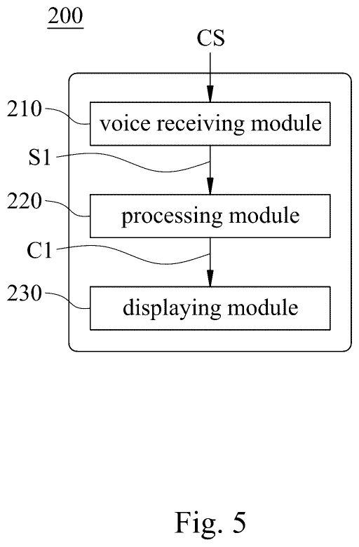

Please refer to FIG. 1. FIG. 1 shows a block diagram of a voice-controlled displaying system according to a first embodiment of the present disclosure. The voice-controlled displaying system 100 includes a controller 110 and a display 120. The controller 110 includes a voice receiving module 111, a processing module 113 and a transmitting module 115. The voice receiving module 111 is configured to receive a speech instruction CS (shown in FIG. 5), and transforms the speech instruction CS into a speech signal S1. The processing module 113 is signally connected to the voice receiving module 111, and identifies the speech signal S1 to generate a controlling instruction C1. The transmitting module 115 is signally connected to the processing module 113, and is configured to transmit the controlling instruction C1. The display 120 includes a receiving module 121 and a displaying module 123. The receiving module 121 is signally connected to the transmitting module 115, and receives the controlling instruction C1. The displaying module 123 is signally connected to the receiving module 121, and displays a display screen D1 (shown in FIG. 4) according to the controlling instruction C1.

In detail, the controller 110 can include a smart speaker, a mobile device, a computer or other electronic devices with voice receiving function, processing function and transmitting function, the voice receiving module 111 can include a microphone or other voice receiving equipment, the processing module 113 can include a microprocessor or other electrical computing devices, the transmitting module 115 and the receiving module 121 can include a communicating device with radio frequency transmitting function, Bluetooth function or other wireless data transmitting functions, the displaying module 123 can include a Liquid Crystal Display (LCD) or Cholesteric LCD (ChLCD), but the present disclosure is not limited thereto.

Further, the user can send a speech instruction CS to the voice receiving module 111 of the controller 110, and the speech instruction CS can be an instruction for switching a state of the displaying module 123. The voice receiving module 111 transforms the speech instruction CS to the speech signal S1, and the processing module 113 recognizes the speech signal S1 and analyzes an action corresponding to the speech signal S1, in order to generate the controlling instruction C1, and transmits the controlling instruction C1 to the display 120 via the transmitting module 115. The display 120 receives the controlling instruction C1 via the receiving module 121, and the displaying module 123 display the display screen D1.

For instance, the user can issue a speech instruction CS such as “display white screen” to the voice receiving module 111, the processing module 113 analyzes the information that the user wants to display from the speech signal S1, and generates the controlling instruction C1, which can control the display 120 to display the aforementioned information. The displaying module 123 can display the display screen D1 (such as white screen) corresponding to the speech instruction CS after receiving the controlling instruction C1. Thus, the user can control or switch the display screen D1 of the display 120 via the controller 110 disposed out of the display 120 of the voice-controlled displaying system 100.

In the first embodiment, the displaying module 123 can be a ChLCD, the controlling instruction C1 is configured to driving the displaying module 123 to switch between a transparent screen and a non-transparent screen. When the user issues the speech instruction CS, which is corresponding to the action for switching between the transparent screen and the non-transparent screen, to the voice receiving module 111, the displaying module can switch the displaying state according to the controlling instruction C1 corresponding to the transparent screen and the non-transparent screen. When the display screen D1 of the displaying module 123 is in a non-transparent state, the display 120 can be a partition wall, which can obstruct the sight in the interior space, the display 120 do not reflect light in the dark environment. Hence, the user visual burden will not increase.

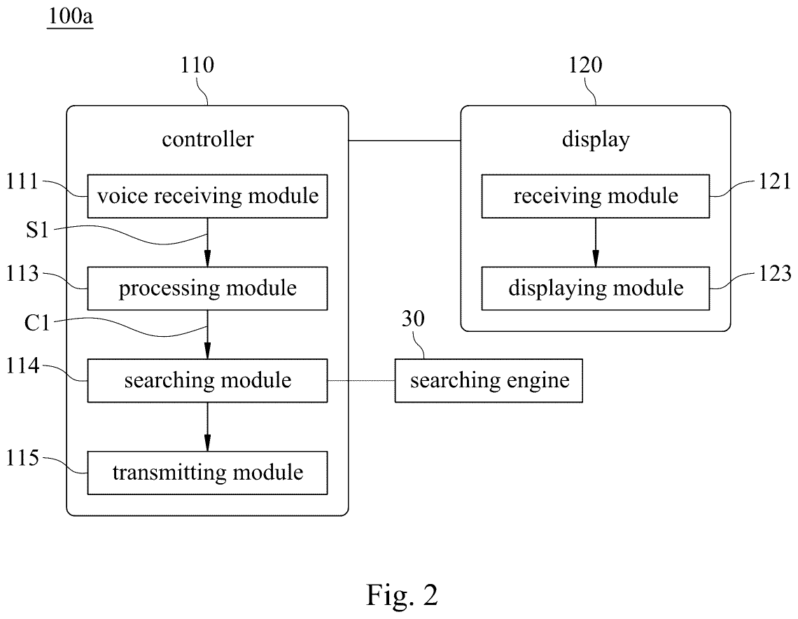

Please refer to FIG. 1 and FIG. 2. FIG. 2 shows a block diagram of a voice-controlled displaying system according to a second embodiment of the present disclosure. The voice-controlled displaying system 100a includes a controller 110 and a display 120. The controller 110 includes a voice receiving module 111, a processing module 113 and a transmitting module 115. The display 120 includes a receiving module 121 and a displaying module 123. In the second embodiment, the voice receiving module 111, the processing module 113, the transmitting module 115, the receiving module 121 and the displaying module 123 are the same as the voice receiving module 111, the processing module 113, the transmitting module 115, the receiving module 121 and the displaying module 123 of the voice-controlled displaying system 100 in the first embodiment, respectively, and will not be described again. Further, the controller 110 can further include a searching module 114.

The searching module 114 is signally connected to the processing module 113, and is configured to connect to a searching engine 30 via an internet, so as to search an instruction information corresponding to the controlling instruction C1 from the searching engine 30. The transmitting module 115 transmits the controlling instruction C1 and the instruction information to the display 120, and the displaying module 123 displays the display screen D1 (shown in FIG. 4) according to the controlling instruction C1 and the instruction information.

In the second embodiment, when the user issue an instruction corresponding to view a specific information, the processing module 113 can configure the searching module 114 to search the aforementioned specific information (i.e., the instruction information) from the searching engine 30, and transmit both of the instruction information and the controlling instruction C1 to the receiving module 121 of the display 120. The displaying module 123 displays the display screen D1. The display screen D1 can include at least one of an image information, a weather information, a stock market information, a map guiding information, but the present disclosure is not limited thereto. Due to the displaying module 123 is a ChLCD that only consumes power during switching the display screen D1, the voice-controlled displaying system 100a of the present disclosure can be used as a hanging picture or a wallpaper device, which can change the content base to the user request.

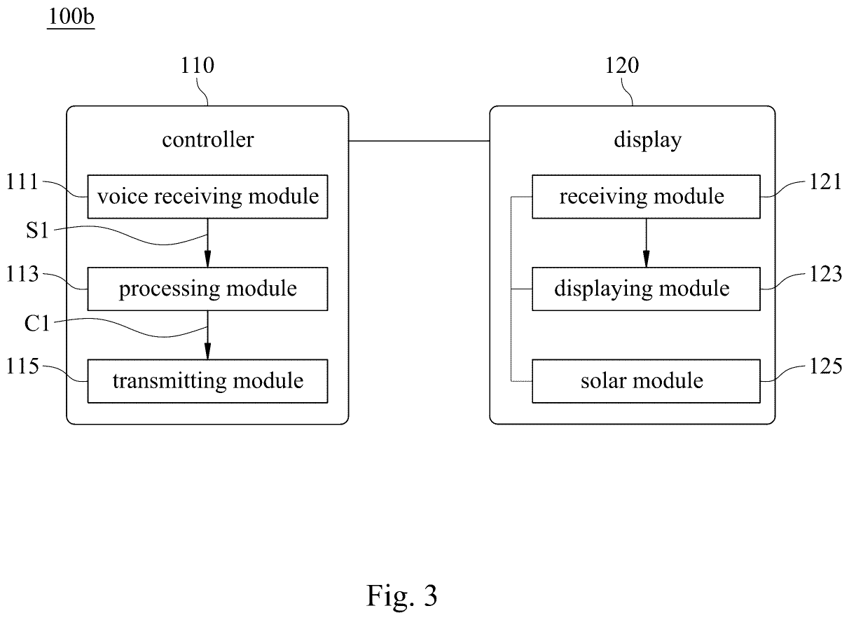

Please refer to FIG. 1 and FIG. 3. FIG. 3 shows a block diagram of a voice-controlled displaying system according to a third embodiment of the present disclosure. The voice-controlled displaying system 100b includes a controller 110 and a display 120. The controller 110 includes a voice receiving module 111, a processing module 113 and a transmitting module 115. The display 120 includes a receiving module 121 and a displaying module 123. In the third embodiment, the voice receiving module 111, the processing module 113, the transmitting module 115, the receiving module 121 and the displaying module 123 are the same as the voice receiving module 111, the processing module 113, the transmitting module 115, the receiving module 121 and the displaying module 123 of the voice-controlled displaying system 100 in the first embodiment, respectively, and will not be described again. Further, the display 120 can further include a solar module 125. The solar module 125 is electrically connected to the receiving module 121 and the displaying module 123, and is configured to transform an ambient light to a power, and supply the power to the receiving module 121 and the displaying module 123.

By absorbing the ambient light and transforming into the electric power via the solar module 125, the voice-controlled displaying system 100b of the present disclosure can be disposed at outdoor environment movably without additional power.

Please refer to FIG. 1 and FIG. 4. FIG. 4 shows a block diagram of a voice-controlled displaying system according to a fourth embodiment of the present disclosure. The voice-controlled displaying system 100c includes a controller 110 and a display 120. The controller 110 includes a voice receiving module, a processing module and a transmitting module. The display 120 includes a receiving module and a displaying module. In the fourth embodiment, the voice receiving module, the processing module, the transmitting module, the receiving module and the displaying module are the same as the voice receiving module 111, the processing module 113, the transmitting module 115, the receiving module 121 and the displaying module 123 of the voice-controlled displaying system 100 in the first embodiment, respectively, and will not be described again. Further, the controller 110 is a smart speaker or an intelligent voice assistant in a home environment. The user can issue the speech instruction to the controller 110, to controller the controller 110 to display the display screen D1 that the user wants to view.

Please refer to FIG. 5. FIG. 5 shows a block diagram of a voice-controlled display according to a fifth embodiment of the present disclosure. The voice-controlled display 200 includes a voice receiving module 210, a processing module 220 and a displaying module 230. The voice receiving module 210 is configured to receive a speech instruction CS, and transforms the speech instruction CS into a speech signal S1. The processing module 220 is signally connected to the voice receiving module 210, and identifies the speech signal S1 to generate a controlling instruction C1. The displaying module 230 is signally connected to the processing module 220, and displays a display screen (not shown in FIG. 5) according to the controlling instruction C1.

In other words, the user can input the speech instruction CS via the voice receiving module 210, and transform the speech instruction CS into the speech signal S1. The processing module 220 can identify the controlling instruction C1 corresponding to the speech signal S1, and display the display screen corresponding to the speech instruction CS via the displaying module 230.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A voice-controlled displaying system, comprising:
a controller, comprising:
a voice receiving module configured to receive a speech instruction, and transform the speech instruction into a speech signal;
a processing module signally connected to the voice receiving module, and identifying the speech signal to generate a controlling instruction; and
a transmitting module signally connected to the processing module, and configured to transmit the controlling instruction; and
a display, comprising:
a receiving module signally connected to the transmitting module, and receiving the controlling instruction; and
a displaying module signally connected to the receiving module, and displaying a display screen according to the controlling instruction.

2. The voice-controlled displaying system of claim 1, wherein the controller further comprises:
a searching module signally connected to the processing module, and configured to connect to a searching engine via an internet, so as to search an instruction information corresponding to the controlling instruction from the searching engine;
wherein the transmitting module transmits the controlling instruction and the instruction information to the display, and the display displays the display screen according to the controlling instruction and the instruction information.

3. The voice-controlled displaying system of claim 1, wherein the display screen comprises at least one of an image information, a weather information, a stock market information and a map guiding information.

4. The voice-controlled displaying system of claim 1, wherein the display further comprises:
a solar module electrically connected to the receiving module and the displaying module, and configured to transform an ambient light to a power, and supply the power to the receiving module and the displaying module.

5. The voice-controlled displaying system of claim 1, wherein the controller is a smart speaker, the displaying module is a Cholesteric Liquid Crystal Display (ChLCD), and the controlling instruction is configured to drive the display screen switching between a transparent screen and a non-transparent screen.

6. A voice-controlled display, comprising:
a voice receiving module configured to receive a speech instruction, and transform the speech instruction into a speech signal;
a processing module signally connected to the voice receiving module, and identifying the speech signal to generate a controlling instruction; and
a displaying module signally connected to the processing module, and displaying a display screen according to the controlling instruction.

7. The voice-controlled display of claim 6, further comprising:
a searching module signally connected to the processing module and displaying module, and configured to connected to a searching engine via an internet, so as to search an instruction information corresponding to the controlling instruction from the searching engine;
wherein the displaying module displays the display screen according to the controlling instruction and the instruction information.

8. The voice-controlled display of claim 6, wherein the display screen comprises at least one of an image information, a weather information, a stock market information, a map guiding information.

9. The voice-controlled display of claim 6, further comprising:
a solar module electrically connected to the displaying module, and configured to transform an ambient light to a power, and supply the power to the voice receiving module, the processing module and the displaying module.

10. The voice-controlled display of claim 6, wherein the displaying module is a Cholesteric Liquid Crystal Display (ChLCD), and the controlling instruction is configured to drive the display screen switching between a transparent screen and a non-transparent screen.
